(19) United States
(12) Patent Application Publication
(10) Pub. No.: US 2019/0085969 A1
(43) Pub. Date: Mar. 21, 2019

(54) Isochoric Transmission Fluid Change Mechanism

(71) Applicant: John Tianci Li, Roslyn Heights, NY (US)

(72) Inventor: John Tianci Li, Roslyn Heights, NY (US)

(21) Appl. No.: 15/709,441

(22) Filed: Sep. 19, 2017

(51) Int. Cl. F16H 57/04

(52) U.S. Cl. CPC F16H 57/0408

(57) ABSTRACT

An isochoric mechanism for changing transmission fluid composed of a box component, two bags, two valves, a board, plastic tubing, and two adapters. The mechanism ensures that the same amount of new transmission fluid is injected into the transmission system as the amount of old transmission fluid that is drained out of the transmission fluid reservoir. Mechanism is driven by gravity, and usage requires two supports that are of equal height, to support the body of the mechanism using the board component. Valves ensure that the system can be stored and reused. Automatically collects old transmission fluid for recycling, and upon return to the provider, the mechanism may be refilled with new transmission fluid.

### CROSS-REFERENCE TO RELATED APPLICATIONS

Not Applicable

### BACKGROUND OF THE INVENTION

### Technical Field of the Invention

The present invention relates to a reusable mechanism that simplifies transmission fluid changes for automobiles.

### Background and Prior Art

Transmission fluid is recommended to be changed every 30,000 miles, or 2 years. The prior art standard method is to place a drain pan below the transmission fluid reservoir, remove the drain plug on the bottom of the transmission reservoir, and let the fluid drain out. This process usually requires about 20 minutes, costs approximately 100 USD, and requires extensive cleanup due to fluid splashing out of the drain pan, or other forms of spillage. An additional complication arises due to this loss of transmission fluid, because the amount of fluid drained out must be replaced by an almost exact amount of new fluid. In the prior art method, the fluid must be poured from the drain pan into a container to measure the amount of fluid that has been drained out, which very often leads to more spillage. Contamination of the surroundings creates the unnecessary extra step of cleaning up the fluid and leads to pollution. The invention proposed addresses the aforementioned problems.

### SUMMARY OF THE INVENTION

The invention proposed is a reusable mechanism that solves the aforementioned problems that are present in the prior art standard. It consists of a box, two bags, two valves, a board, and some plastic tubing. The box contains the two bags, one of which is filled with new transmission fluid, and the other, which collects the used transmission fluid, is empty to begin with. The board is adhered between the two bags, so that when the board is placed between two elevated surfaces, gravity pulls down on the entire mechanism to force the new transmission fluid to flow into the transmission system and suck the old transmission fluid out of the transmission fluid reservoir. The system has two valves that govern whether the transmission fluid is allowed to flow, and allows for the system to be used, reused, and stored without any leakage.

The mechanism is attached to the transmission system of the vehicle through plastic tubing, which allows for the mechanism to be compatible with many different types of vehicles. During changes in transmission, the board between the two bags forces the change in volume of the contents in one bag to be compensated by a corresponding change in volume of the contents in the other. Thus, the system eliminates the need of any sort of measurement, as exactly the same amount of new fluid is put into the system to replenish the amount of used fluid that is taken out. Being that the old fluid directly enters a bag, which can then be closed off, the amount of spillage is minimal to none, thus also reducing the amount of cleaning that is required. The entire mechanism, with the old fluid included, can then be returned. The old fluid is then collected for recycling, and the mechanism is refilled and reused.

### BRIEF DESCRIPTION OF THE DRAWINGS

The appended drawings of the invention are as follows:

FIG. 1 is an isometric view of the invention, which exhibits the valves that are responsible for adding new fluid into the vehicle, and for sealing the old fluid inside the mechanism to be returned.

FIG. 2 is an exploded view of the invention, which exhibits the separate components of the invention.

FIG. 3 is an orthographic view of the box component of the mechanism, which exhibits the two holes that connect to the valves and also to the bags.

FIG. 4 is an orthographic view of the box component of the mechanism, which exhibits the frame that the board slides along during the usage of the mechanism.

FIG. 5 is an isometric view of the box component of the mechanism, which exhibits the protrusion of the box component that allows for the bag to tightly seal to the box and the valve.

FIG. 6 is an isometric view of the cap of the box component of the mechanism.

FIG. 7 is an isometric view of the full bag of transmission fluid, which exhibits the hole which connects it to the corresponding protrusion of the box component and valve. The rendering is simplified, as the bag is more or less similar in geometry to a telescopic bellow or an accordion bellow.

FIG. 8 is an isometric view of the empty bag that will be filled with the old transmission fluid, which exhibits the hole which connects it to the corresponding protrusion of the box component and valve. The empty bag is identical to the full bag, except in position of placement, and type of fluid that is meant to be contained.

FIG. 9 is an orthographic view of the board, which exhibits the slots that allow for the frame of the box component to guide the board's path during operation of the mechanism, and a cut out notch that enables the mechanism to be assembled.

FIG. 10 is an orthographic view of a thin sheet of adhesive that connects the board to both bags. However, note that using plastic straps is another viable option to connect the board to the bags, and can potentially eliminate this component.

FIG. 11 is an isometric view of the valve that is utilized in the invention to allow for the mechanism to be stored, sealed, and reused.

FIG. 12 is an isometric view of the adapter that connects to the valve that directs the new transmission fluid using plastic tubing.

FIG. 13 is an orthographic view of the adapter that connects to the valve that directs the old transmission fluid into the mechanism using plastic tubing.

FIG. 14 is an orthographic view of both adapters being coupled during storage, and before and after use.

FIG. 15 is an orthographic view of the main body of the mechanism, when the mechanism is in use.

FIG. 16 is an orthographic view of the main body of the mechanism, when the procedure of changing the transmission fluid is completed.

### DETAILED DESCRIPTION OF THE INVENTION

The mechanism primarily is comprised of a box component, a board component, two bags, two valves, two adapters, and a cap for the box. The mechanism's operation is dependent on gravity, to provide the driving force. When in operation, the complete mechanism as seen in FIG. 1 is supported by the board on two elevated surfaces of equal height, connected to the vehicle by plastic tubing and two adapters, and the valves are opened, to allow for the transmission fluid to be changed. The weight of the system pushes out the new transmission fluid, and since the board is connected to both boxes, this also leads to a corresponding suction of the old transmission fluid from the transmission reservoir. The top valve, as referred to by reference character 1, is responsible for allowing the new fluid to exit the mechanism, and the bottom valve, as referred to by reference character 2, is responsible for allowing the old fluid to enter the mechanism, which will then be returned, so that the fluid may be recycled, and the mechanism may be reused.

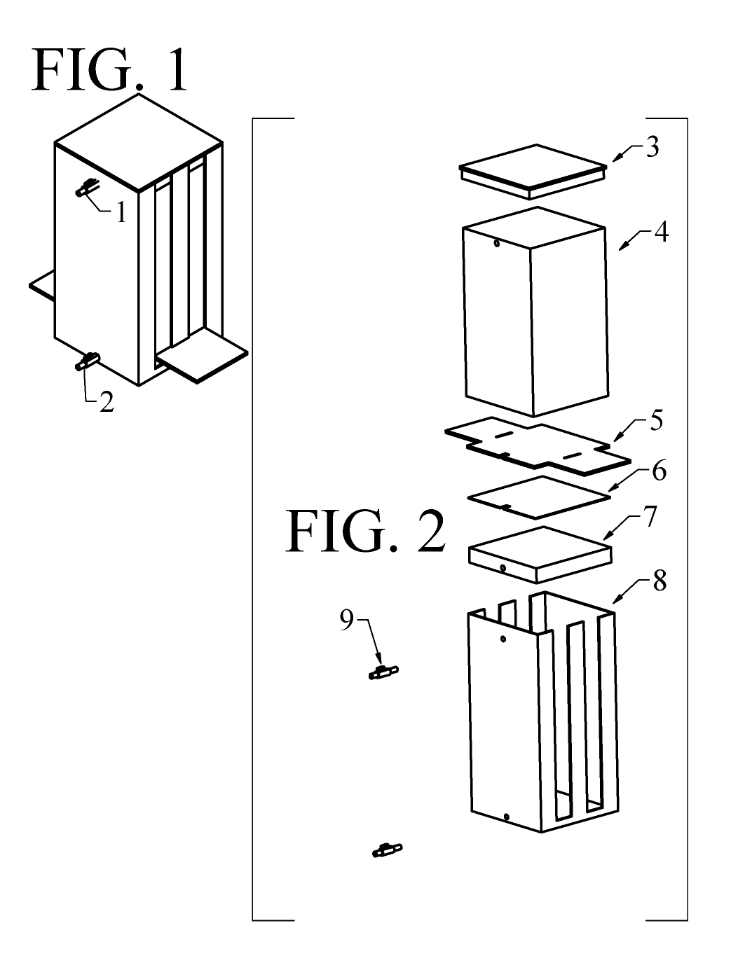

The separate components of the main body of the system is exhibited by the exploded view provided as FIG. 2. Reference character 3 refers to the cap of the box component of the system, reference character 4 refers to the full bag of new transmission fluid that is supplied with the system, reference character 5 refers to the board that is responsible for driving the mechanism, reference character 6 refers to a layer of adhesive that connects the board to the bags, reference character 7 refers to an empty bag that collects the old transmission fluid, reference character 8 refers to the box component of the mechanism, and reference character 9 refers to the valves that are utilized to direct and seal the flow of the transmission fluid. This constitutes the main body. The only parts that are not exhibited in FIG. 2 are the 2 adapters, and their corresponding lengths of plastic tubing.

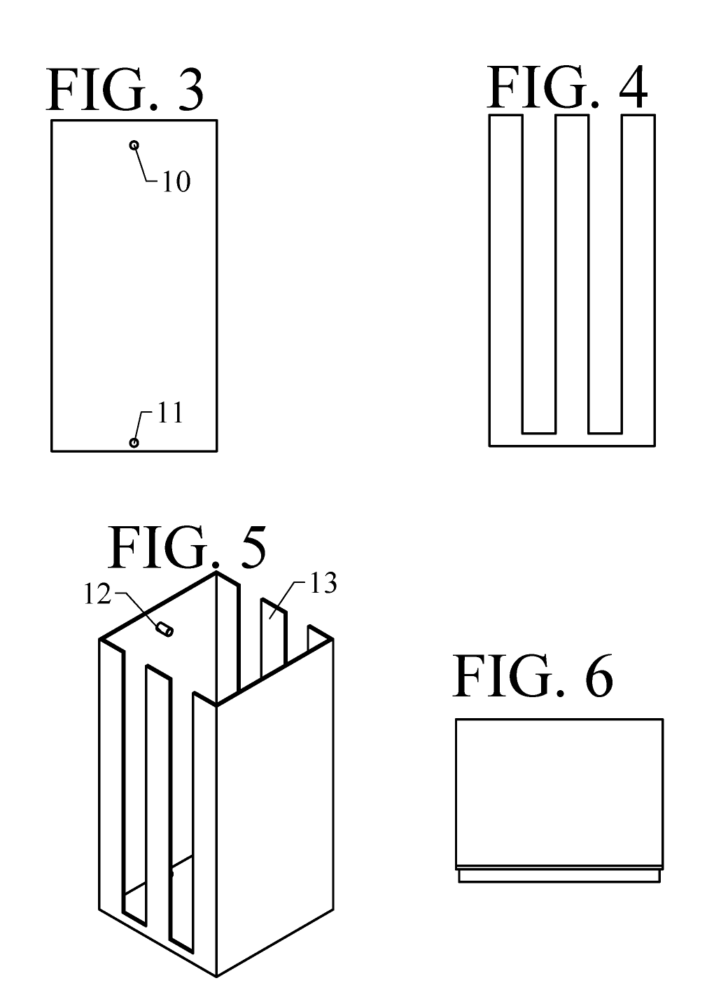

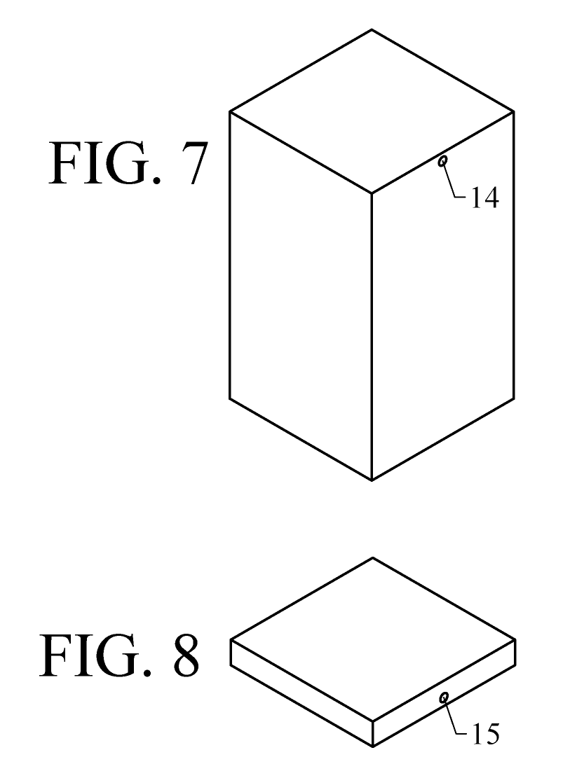

The main bulk of the system is the box component, which houses the majority of the other components. As seen in FIG. 3, the box component has two openings, as indicated by reference character 10 and reference character 11, which allow for the valves to be attached, and for the transmission fluid to flow. FIG. 4 is simply FIG. 3 rotated by 90 degrees, and FIG. 4 exhibits the frame of the box component. This frame allows for the board to be inserted into the box component, and helps to guide the board as the board moves along the length of the box during the operation of the mechanism. As shown in FIG. 5, the box component also has a protrusion, as indicated by reference character 12, that corresponds to the opening of the box as shown by reference character 10 in FIG. 3. There is another protrusion that corresponds to reference character 11, but it is blocked by the frame portion of the box component in FIG. 5. This protrusion allows for the bag to be inserted onto the protrusion, and also secures the valve, thus allowing for a tight seal that will not leak. Reference character 13 points to a single vertical member of the frame of the box component, which is inserted through a slot in the board when the board is installed into the box.

The box component is closed by a cap, which is shown in FIG. 6. This cap may be bolted on, attached by adhesive, or fused onto the box after the box is assembled. The cap is an essential component of the mechanism, and its function is not to solely keep all the components of the body inside the box component. When gravity pulls the mechanism down, the board pushes the full bag of new transmission fluid against this cap, which leads to the new transmission fluid being forced out of the mechanism, and into the vehicle.

The filled bag of transmission fluid is shown in the highly simplified FIG. 5. In practice, the bag most likely resembles a telescopic bellow, or an accordion bellow. Reference character 14 serves to indicate that there is a hole in the bag which corresponds to the protrusion of the box component referred to by reference character 12, and the hole has a small sleeve of rubber and some adhesive that ensures a tight seal with the protrusion. Likewise, the same applies for the empty bag, as shown in FIG. 6. In fact, the two bags are identical, and the only distinctions between them are their starting positions, and the fluids that they are intended to contain. Thus, when the full bag of new transmission fluid depicted in FIG. 5 is emptied, the bag would be similar to the empty bag depicted in FIG. 6, and when the empty bag depicted in FIG. 6 is filled with used transmission fluid, the bag would be similar to the full bag depicted in FIG. 5. Using the same type of bag for both applications allows for easier manufacturing, as it is easier to utilize the same component for both purposes. The bags are made of durable plastic, and are meant to be reused along with the rest of the mechanism.

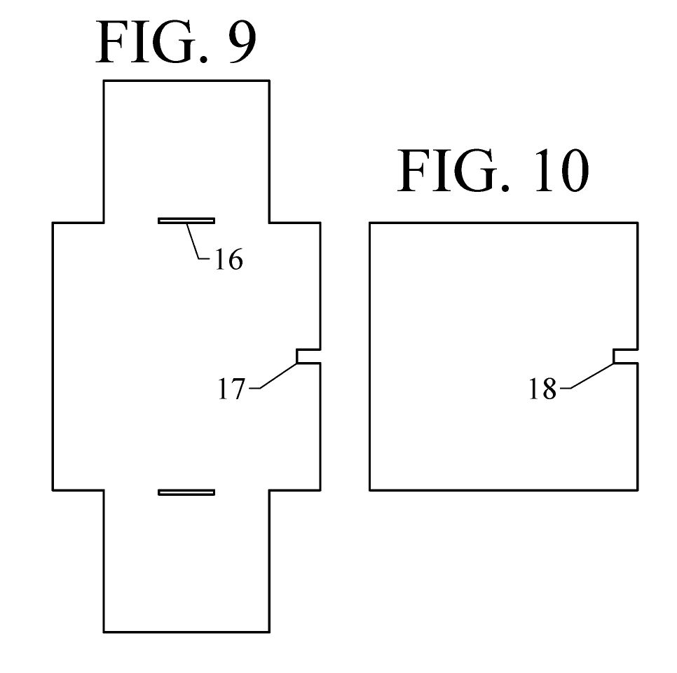

The board is depicted in FIG. 9, and it is complementary with the geometry of the box component. The board is inserted into the box, and the vertical portions of the frame pass through the slots designated as reference character 16. Reference character 17 refers to a cut out notch in the board that allows for it the mechanism to be assembled, as without the notch, the board would not fit because of the protrusion in the box system. FIG. 10 is a proposed layer of adhesive, that belongs between the board and the two bags, in order to ensure that both bags move the same distance, so that the same amount of transmission fluid is replenished as is taken out. Note, that a similar notch with the same purpose as the notch as indicated by reference character 17 is present, and is referred to by reference character 18.

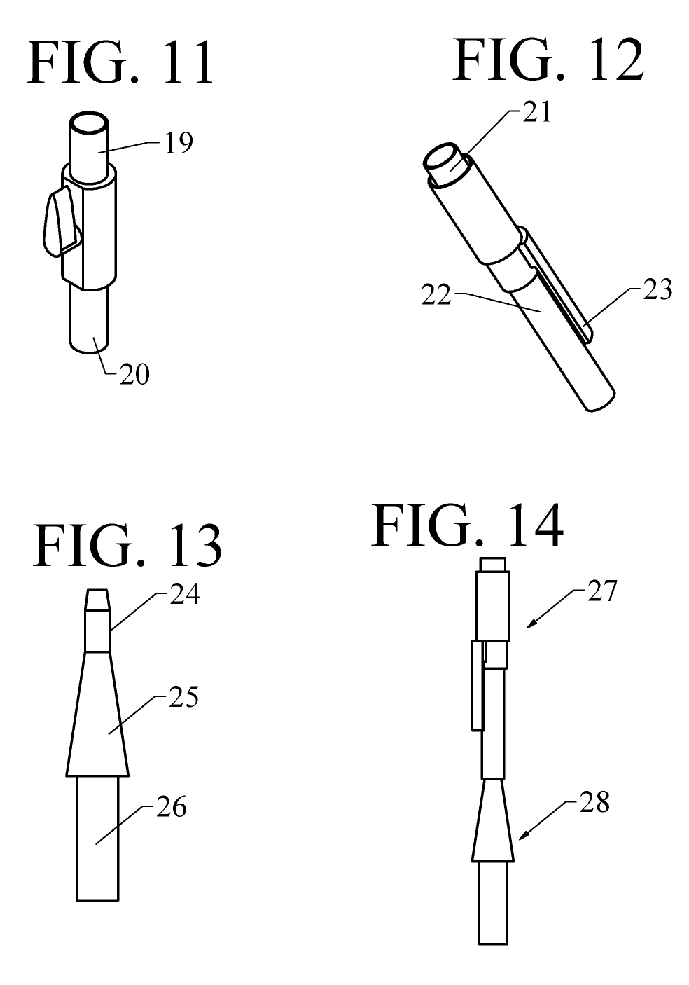

To connect the valves that are the corresponding outlet and inlet of the system to the vehicle, adapters and plastic tubing are utilized. As shown in FIG. 11, the valve has two lengths of pipe that extend outwards. Reference character 20 indicates the portion of the valve that is inserted into the box component, and connects the valve to the bag containing the transmission fluid. The bag is connected to the protrusion of the box component using a rubber seal and some adhesive. The inside of the protrusion is threaded, and the valve, being a more permanent component, is screwed into the protrusion. Thus, although not shown in FIG. 11, the length of pipe indicated by reference character 20 is threaded. The length of pipe that is indicated by reference character 19 is inserted into a plastic tube, which attaches to a corresponding adapter that allows for the fluid to be transferred between the mechanism and the vehicle.

For new fluid that is to be infused into the vehicle, the adapter as shown in FIG. 12 is utilized. The adapter connects to the plastic tube through the length of pipe as indicated by reference character 21, and is inserted into the transmission fluid dipstick hole. The adapter is held in place during the operation of the mechanism by a piece of metal that surrounds the pipe of the transmission fluid dipstick hole, as indicated by reference character number 23. For old fluid that is to be removed from the transmission fluid reservoir, the adapter as depicted in FIG. 13 is utilized. This adapter is inserted into the hole of the drain bolt of the transmission filter reservoir, and is designed to fit most vehicles with drain bolt holes of various diameters. Reference character 24 indicates the section that allows for compatibility with drain bolts of smaller diameters, reference character 25 indicates the section that allows for compatibility with drain bolt holes of larger diameters, and reference character 26 refers to a length of pipe with which the adapter is attached to plastic tubing. The adapter is partially made of rubber, to enhance sealing with the drain bolt holes during the operation of the mechanism. However, in the future, the drain bolt may be replaced by a valve, so this adapter may likewise be removed so that the plastic tubing may then be directly utilized. During storage, the two adapters depicted in FIG. 12 and FIG. 13 couple, as depicted in FIG. 14. This prevents leakage of the residue fluid that may be inside the plastic tubing, especially when the mechanism has been used or reused. Thus, reference character 27 is the adapter depicted in FIG. 12, and reference character 28 is the adapter depicted in FIG. 13 that is now inserted into the portion of the adapter as referred to by reference number 22.

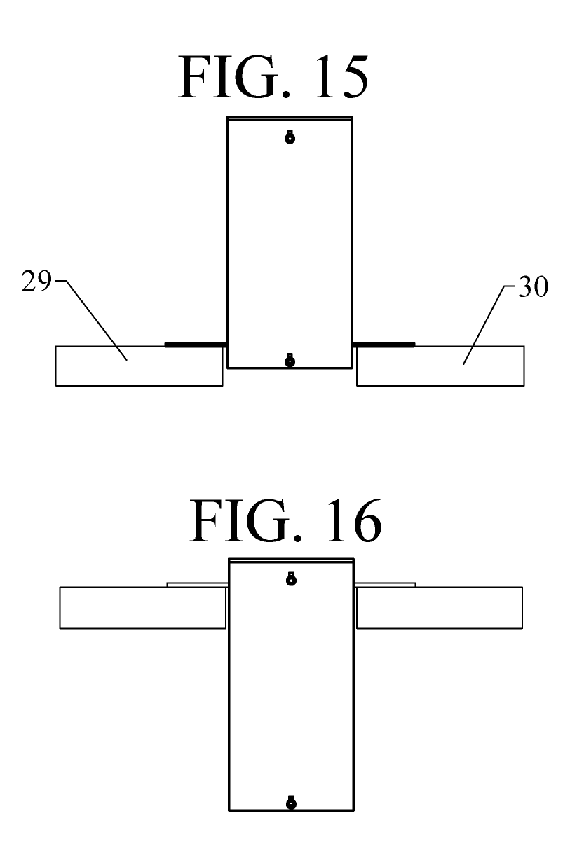

The proposed mechanism functions as follows. The mechanism is rented as depicted in FIG. 1. Inside the mechanism is an amount of new transmission fluid that comes along with the system. The system is attached to the vehicle by plastic tubing and the adapters shown in FIG. 12 and FIG. 13. Then, the body of the system is placed upon two supports, as shown in FIG. 15. The two supports must be of the same height, and they support the system by means of the board. Thus, reference character 29 and reference character 30 refer to the two supports. When the valves are opened, fluid flow is allowed. Thus, the weight of the system would push out the new transmission fluid, and suck in exactly the same amount of old fluid. When the procedure is finished, the mechanism would look like the situation shown in FIG. 16. Then, to seal in the old fluid, the valves are closed, and the two adapters are coupled as shown in FIG. 14. To refill the mechanism for reuse, the emptied bag would be filled and the old fluid would be removed by performing the reverse of the procedure that is carried out during usage. Thus, the mechanism is turned upside down, and old fluid is pushed out into a waste disposal unit, while new fluid is sucked in. Thus, the old fluid is returned along with the mechanism, so that the old fluid may be recycled, and the mechanism may be reused.

The proposed procedure with the proposed mechanism requires less time that the prior art standard, as there is no more spillage to clean up. Also, since the mechanism simplifies transmission fluid changes to the point where they are easily performed by most car owners, the car owners can save approximately $50 USD. Using a ten-thousand-point recursive mathematical model, the system can change out about 85% of the transmission fluid in the transmission system, whereas the prior art procedure only changes out about 75% of the amount of transmission fluid in the reservoir. This increase in efficiency benefits the car owner and also the environment. Thus, reduction of cost for car owners, reduction of cleanup for the procedure, reduction of waste, reduction of contamination of the surroundings, and increase in efficiency all contribute to the motive of the proposed invention.

The invention claimed is:

1. An isochoric mechanism for changing transmission fluid, which utilizes gravity as the driving force for operation.

2. The mechanism according to claim 1, wherein the mechanism is composed of a main body inside a box component, a board, two valves, and two bags.

3. The mechanism according to claim 1, wherein a board attached to two bags ensures that the amount of old transmission fluid that is drained out of the system is replaced by the same amount of new transmission fluid.

4. The mechanism according to claim 1, wherein the compartments that contains the transmission fluid are two plastic bags.

5. The mechanism according to claim 1, wherein the transmission fluid is contained in the bags, which are then opened or closed off by valves.

6. The mechanism according to claim 1, wherein the compartment containing the transmission fluid has the geometry of a telescopic bellow, or an accordion bellow.

7. The mechanism according to claim 1, wherein the system is operated by supporting the mechanism by a component that is situated intermediate to both compartments that are intended to hold transmission fluid.

8. The mechanism according to claim 1, wherein the system has a board that propels the function of the mechanism, and the board is guided by a set of rails in the box mechanism.

9. The mechanism according to claim 1, wherein the plastic bags that holds the transmission fluid are identical, except for their relative position, and the age of the fluid that they are intended to contain.

10. The mechanism according to claim 1, wherein one plastic bag begins full of new transmission fluid, whereas the other plastic bag begins empty, and that through the course of operation of the mechanism, the previously empty plastic bag is filled with old transmission fluid, and the previously full plastic bag emptied its new transmission fluid into the vehicle.

11. The mechanism according to claim 1, wherein the transmission fluid flow is directed by plastic tubing and controlled by valves.

12. The mechanism according to claim 1, wherein the plastic tubing has adapters to allow for the mechanism to be compatible with a wide array of vehicles.

13. The mechanism according to claim 1, wherein the adapters may also be compatible with valves.

14. The mechanism according to claim 1, wherein the adapters can couple, to trap in transmission fluid residue in the plastic tubing, so that the transmission fluid does not leak out.

15. The mechanism according to claim 1, wherein the mechanism may be returned along with the old transmission fluid contained within the system, so that the old transmission fluid may be recycled, and the mechanism may be refilled and reused.

16. The mechanism according to claim 1, wherein the mechanism may be rented, and the transmission fluid may be bought, so that the return of the mechanism along with used transmission fluid is encouraged, much like in the spirit of recycling water bottles.
